(19) United States
(12) Patent Application Publication
(10) Pub. No.: US 2005/0194107 A1
(43) Pub. Date: Sep. 8, 2005

(54) Retractable slat and window blind using same

(76) Inventor: Ming Nien, Changhua Hsien (TW)

Correspondence Address: BIRCH STEWART KOLASCH & BIRCH, PO BOX 747, FALLS CHURCH, VA, 22040-0747, US

(21) Appl. No.: 10/896,943

(22) Filed: Jul. 23, 2004

(30) Foreign Application Priority Data
Mar. 5, 2004 (TW) 093203374

(51) Int. Cl. E06B 3/22

(52) U.S. Cl. 160/236

(57) ABSTRACT

A retractable blind slat for a window blind includes an elongated first slat element and an elongated second slat element that is axially moveably coupled to the first slat element. The second slat element has a plurality of locating grooves and the first slat element has a retaining block selectively engaged with one of the locating grooves to immobilize the second slat element relative to the first slat element.

### BACKGROUND OF THE INVENTION

1. Field of the Invention

The present invention relates to slats for window blinds and more particularly, to the retractable slats for window blinds. The present invention also relates to the window blind which has retractable components, such as slats, headrail and bottom rail.

2. Description of the Related Art

Regular window blinds include vertical type that has slats vertically spacedly suspended below the headrail and horizontal type that has slats horizontally spacedly suspended below the headrail. Manufacturers simply provide limited sizes of window blinds for selection. For example, horizontal type window blinds range from 17″ to 73″ at a pitch of 1″ or 2″. When buying a window blind, the consumer must select a size relatively greater than that of the window that is to be installed with the window blind, and then use a blind cutting machine to cut the selected window blind to approximately equal to the size of the window. At final, the properly cut window blind is installed in the window.

According to the aforesaid method, the consumer must measure the size of the window, and then select a suitable size of window blind, and then measure the size to cut, and then cut the selected window blind subject to the desired size. If the size of the window blind after a first cut does not fit the window perfectly, a secondary cut may be necessary. However, in case of an overcut, the window blind becomes not usable. Further, a distributor or sales center must provide a window blind cutting machine for cutting window blinds that are sold out. The installation cost of such a window blind cutting machine is high. Further, it is necessary to train a person to use the installed window blind cutting machine. The installation of a window blind cutting machine and the training of a person to use the installed window blind cutting machine greatly increase the running cost of the business. A defective product due to an overcut is a burden to the distributor or sales center.

### SUMMARY OF THE INVENTION

It is the primary objective of the present invention to provide a retractable window blind, which can be conveniently adjusted in size subject to the size of the window that is installed or to be installed with the window blind.

It is another objective of the present invention to provide a window blind having retractable slats, which eliminates the necessity of cutting the size to fit the window, thereby saving the cost.

To achieve these objectives of the present invention, the widow blind comprises a retractable headrail and a plurality of retractable slats respectively suspended from the headrail. The slats each comprise an elongated first slat element, an elongated second slat element axially slidably coupled to the first slat element such that the second slat element is movable along a longitudinal axis of the first slat element and extendable out of the first slat element, and means for immobilizing the second slat element relative to the first slat element.

In an embodiment of the present invention, the means for immobilizing the second slat element relative to the first slat element comprises a plurality of locating grooves provided at the second slat element, and a retaining block provided at the first slat element and selectively engaged with one of the locating grooves.

In another embodiment of the present invention, the means for immobilizing the second slat element relative to the first slat element comprises a screw which is screwed in the first slat element and stoppable against the second slat element.

In addition, friction resistance may be employed between the first and second slat elements by insertion of the second slat element into the first slat element in a close fit manner so as to achieve the function of the means for immobilizing the second slat element relative to the first slat element instead of the use of the aforesaid retaining block-and-groove or the screw.

In still another embodiment, the retractable slat comprises a first slat element and second and third slat elements respectively coupled to the first slat element and slidable and positionable on the first slat.

### BRIEF DESCRIPTION OF THE DRAWINGS

FIG. 1 is a perspective view showing retractable slats used in a vertical type window blind according to a first preferred embodiment of the present invention.

FIG. 2 is a perspective view of the retractable slat according to the first preferred embodiment of the present invention.

FIG. 3 is a sectional view taken along line 3-3 of FIG. 2.

FIG. 4 is a perspective view showing retractable slats used in a horizontal type window blind according to a second preferred embodiment of the present invention.

FIG. 5 is a perspective view of the retractable slat according to the second preferred embodiment of the present invention.

FIG. 6 is a sectional view taken along line 6-6 of FIG. 4.

FIG. 7 is a perspective view showing retractable slats used in a horizontal window blind according to a third preferred embodiment of the present invention.

FIG. 8 is a perspective view of the retractable slat according to the third preferred embodiment of the present invention.

FIG. 9 is a sectional view taken along line 9-9 of FIG. 8.

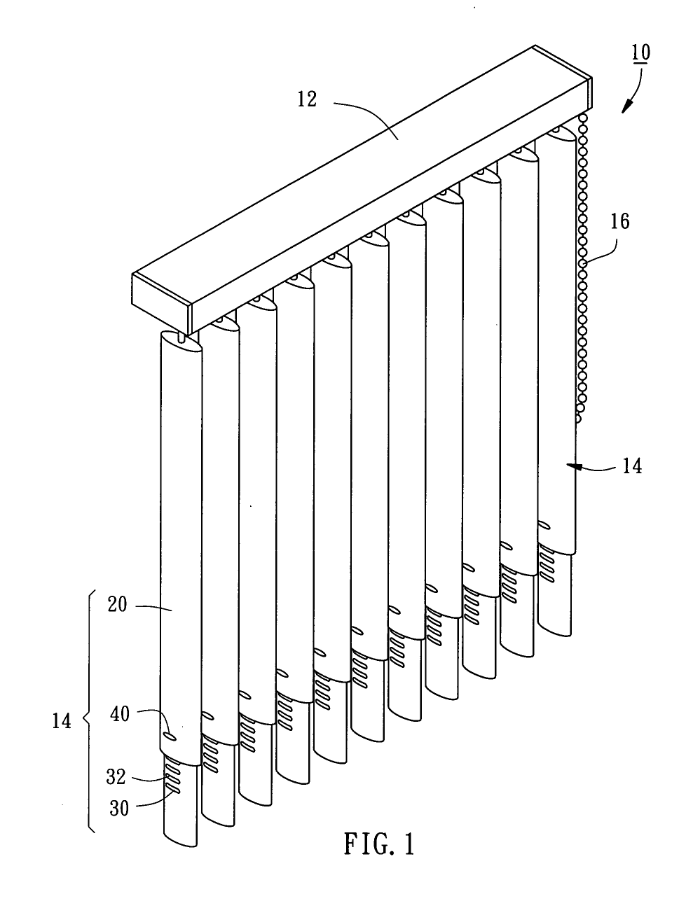

### DETAILED DESCRIPTION OF THE INVENTION

Referring to FIGS. I and 2, a window blind 10 provided by the first preferred embodiment of the present invention is shown comprising a headrail 12, a plurality of retractable slats 14, and a control cord unit 16. The headrail 12 is to be fastened to the top side of the window in horizontal. The slats 14 are vertically suspended from the bottom side of the headrail 12 and equally spaced at the same pitch. The control cord unit 16 is provided at one end of the headrail 12 such that the user can operate the control cord unit 16 to receive and extend out or to tilt the slats 14. The structural connection between the headrail 12, slats 14 and control cord unit 16 is of the known art not within the feature of the present invention; therefore no further detailed description in this regard is necessary.

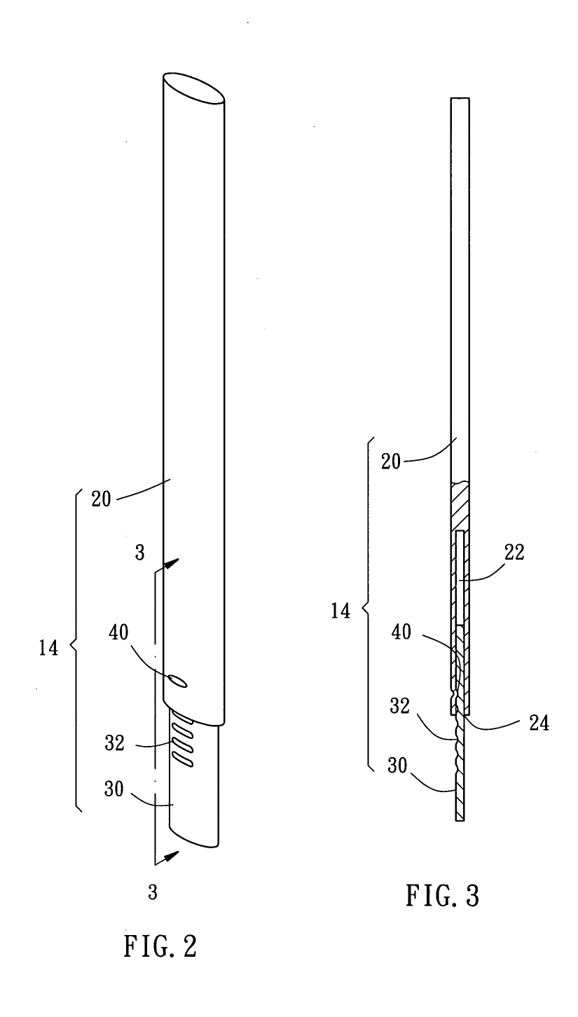

The main feature of the present invention is the retractable design of the retractable slats 14. As shown in FIGS. 2 and 3, each slat 14 comprises a first slat element 20, a second slat element 30 slidably coupled to the first slat element 20, and means for immobilizing the second slat element 30 relative to the first slat element 20, which comprises a retaining member 40.

The first slat element 20 is a narrow elongated hollow shell having an axially extended receiving chamber 22 along a longitudinal axis thereof and an opening 24 in one end in communication with the receiving chamber 22. The other end of the first slat element 20 is a close end.

The second slat element 30 is a narrow elongated plate member fitting the internal contour (the receiving chamber 22) of the first slat element 20, having a plurality of locating grooves 32 formed on one side and equally arranged in parallel. The pitch between each two adjacent grooves 32 is designed to be ¼″. The distance between the first locating groove 32 and the last locating groove 32 is designed to be 3″. The locating grooves 32 curve inwards from the peripheral surface of the second slat element 30, and extend in direction along the minor axis of the second slat element 30. The second slat element 30 has the top end thereof inserted through the opening 24 of the first slat element 20 into the inside of the receiving chamber 22 and the bottom end thereof extending toward the outside of the opening 24, and therefore the second slat element 30 is axially movable along the axially extended receiving chamber 22 of the first slat element 20, i.e., the total length adjusting range of each slat 14 is 3″, and every adjustment unit is ¼″.

The retaining member 40 according to this embodiment is a protruding block formed integral with the inside wall of the first slat element 20 near the opening 24 and projecting toward the inside of the receiving chamber 22. After installation of the second slat element 30 in the first slat element 20, the retaining member 40 engages one of the locating grooves 32 so as to immobilize the second slat element 30 relative to the first slat element 20.

By means of the aforesaid arrangement, the second slat element 30 can be moved in and out of the bottom end of the first slat element 20 and position in one of a series of positions based on the engagement between the retaining member 40 and the locating grooves 32. Because the pitch between each two adjacent locating grooves 32 is ¼″, it needs to move the retaining member 40 over 3 locating grooves 32 if the size to be adjusted is ¾″. When moving the retaining member 40 over one locating groove 32 a click sound is produced. Therefore, the user can judge the adjustment subject to the number of sounds produced. In practice, indication marks may be directly made on the second slat element 30 corresponding to the locations of the locating grooves 32. Alternatively, marks can be printed on a sticker, which is then adhered to the second slat element 30. According to this embodiment, the pitch between each two adjacent locating grooves 32 is ¼″. Alternatively, the pitch can be designed to be ⅛″, ½″, or other size.

Before installation, the second slat element 30 of each retractable slat 14 is inserted through the opening 24 into the receiving chamber 22, keeping one of the locating grooves 32 of the second slat element 30 in engagement with the retaining member 40 of the first slat element 20, and then the top end of the first slat element 20 is pivotally coupled to the headrail 12, keeping the bottom end of the first slat element 20 and the second slat element 30 extending vertically downwards from the headrail 12. During installation, the headrail 12 of the window blind 10 is directly fastened to the top side of the window. After installation, the second slat elements 30 are respectively pushed into or pulled out of the respective first slat elements 20, enabling the slats 14 to shade the whole area of the window.

Therefore, it is not necessary to precisely measure the height of the window and to cut the window blind subject to the size of the window to install. After installation of the window blind in the window, the user can conveniently adjust the vertical length of the slats 14 to shade the whole area of the window.

Further, when the user bought one window blind from the sales center, the user can install the window blind in any window of the house of which the height difference is within 3″, i.e., the user can exchange the window blinds from different windows of the house after a long use.

In design, there is an elevational difference between the first slat element 20 and the second slat element 30. Therefore, the size of the contour of the second slat element 30 is designed to be made closer to that of the first slat element 20. In addition, the first slat element 20 and the second slat element 30 can be made having different colors, thereby showing a sense of color difference beauty.

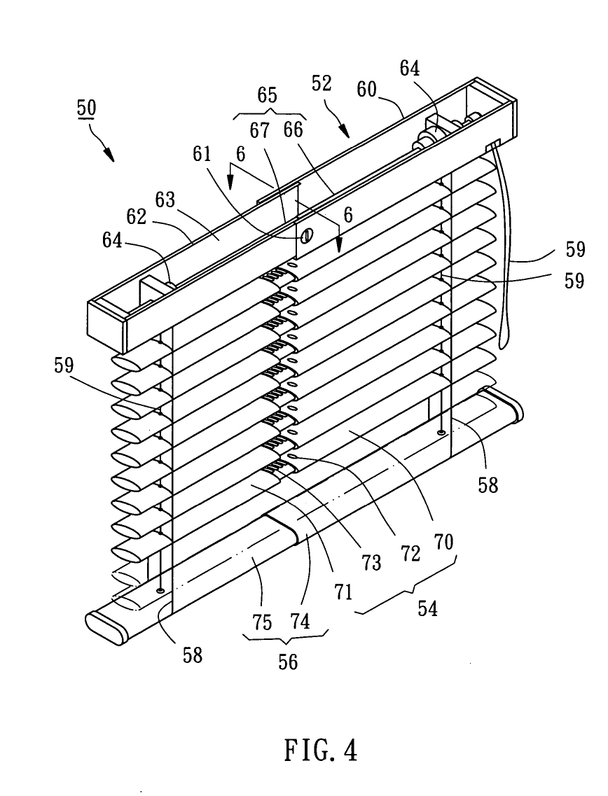

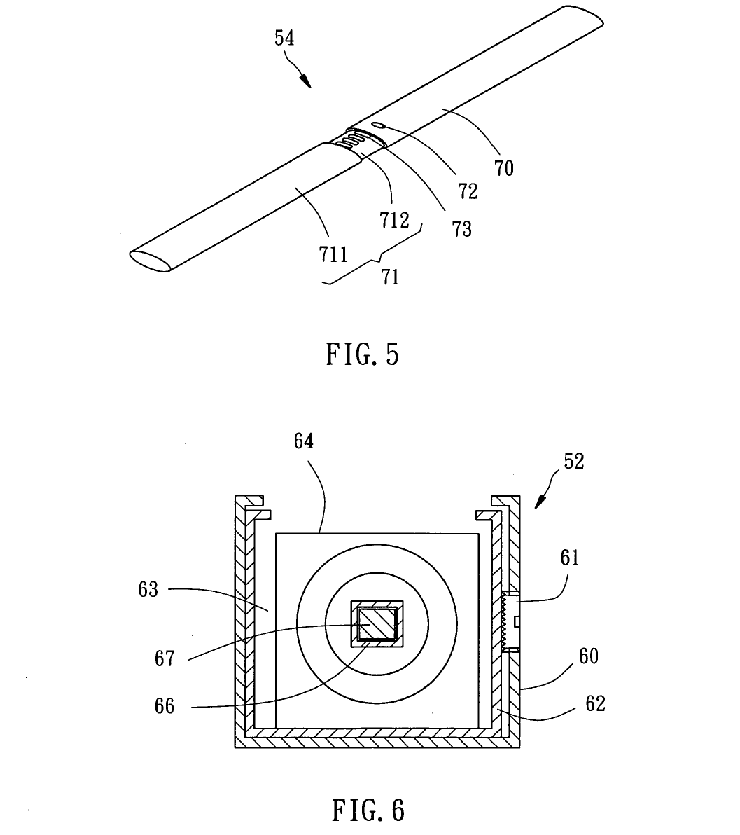

FIGS. 4-6 show a horizontal type window blind constructed according to the second preferred embodiment of the present invention. According to this embodiment, the window blind 50 comprises a retractable headrail 52, a plurality of retractable slats 54, a retractable bottom rail 56, two ladder tapes 58, and a lift cord 59. The retractable slats 54 are horizontally spacedly arranged below the headrail 52. The bottom rail 56 is provided at the bottom side of the retractable slats 54. The ladder tapes 58 are vertically arranged in parallel to join the retractable slats 54 and to hold the retractable slats 54 in parallel, each having a top side inserted into the headrail 52 and a bottom side fastened to the bottom rail 56 for controlling the tilting angle of the retractable slats 54. The lift cord 59 is inserted through the headrail 52, having the bottom end fastened to the bottom rail 56 and the top end inserted through the headrail 52 and then extended out of one end of the headrail 52 for pulling by the user to adjust the elevation of the bottom rail 56.

The headrail 52 comprises a first headrail element 60, a second headrail element 62 axially movable in and out of the first headrail element 60, a retaining member 61 perpendicularly inserted through one lateral sidewall of the first headrail element 60 and adapted to lock the second headrail element 62 to the first headrail element 60. According to this embodiment, the retaining member 61 is a tightening up screw having a serrated tip. The outer contour of the second headrail element 62 fits the internal contour of the first headrail element 60 such that the second headrail element 62 can be moved in and out of the first headrail element 60 to adjust the length of the headrail 52. When adjusted, the retaining member 61 is rotated inwards to lock the second headrail element 62 to the first headrail element 60. The first headrail element 60 and the second headrail element 62 define a narrow elongated open chamber 63. A linkage 65 is pivotally mounted inside the open chamber 63. Two reels 64 are mounted on the linkage 65 and respectively suspended in the first headrail element 60 and the second headrail element 62. The linkage 65 comprises a first member 66 and a second member 67. The first member 66 is a hollow rectangular rod sleeved onto and axially movable along the second member 67.

The structure of the retractable slats 54 is substantially similar to the structure of the retractable slats 14 of the aforesaid first embodiment of the present invention. Each retractable slat 54 is comprised of a hollow first slat element 70, a second slat element 71, and a retaining member 72. The second slat element 71 comprises a base 711 and an adjustment portion 712. The contour of the base 711 is approximately equal to the contour of the first slat element 70. The contour of the adjustment portion 712 is smaller than the first slat element 70. The length of the adjustment portion 712 is sufficient for the adjustment range of 6″ (this data of 6″ is obtained subject to the inventor's long-term observation on conventional horizontal type window blinds). The retaining member 72 is a protruding block formed integral with the inside wall of the first slat element 70. The adjustment portion 712 of the second slat element 71 comprises a plurality of locating grooves 73 transversely arranged in parallel. The pitch between each two adjacent locating grooves 73 is designed to be ½″. The distance between the first locating groove 73 and the last locating groove 73 is designed to be 6″. The adjustment portion 712 of the second slat element 71 is axially slidably inserted into the inside of the first slat element 70. The retaining member 72 is engageable into one locating groove 73 to lock the second slat element 71 to the first slat element 70. Therefore, the total length of each slat 54 is adjustable, i.e., the adjustment range of the total length of each slat 54 is 6″, and every adjustment unit is ½″.

The bottom rail 56 comprises a first hollow bottom rail element 74, a second bottom rail element 75 axially movable inserted into the first bottom rail element 74, and a retaining member (not shown) adapted to lock the second bottom rail element 75 to the first bottom rail element 74.

When wishing to adjust the horizontal length of the horizontal type window blind, move the second slat element 71 of each slat 54 relative to the respective first slat element 70, for enabling the second slat element 71 to be locked to the respective first slat element 70 in the desired position by the respective retaining member 72, and at the same time the second bottom rail element 75 of the bottom rail 56 is moved relative to the first bottom rail element 74 to adjust the bottom rail 56 to the desired length, and then the second headrail element 62 is moved relative to the first headrail element 60 to adjust the headrail 52 to fit the adjusted length of the slats 54, and then the retaining member 61 is threaded into the inside of the first headrail element 60 to lock the second headrail element 62 to the first headrail element 60. Thus, the adjustment of the horizontal window blind 50 is done.

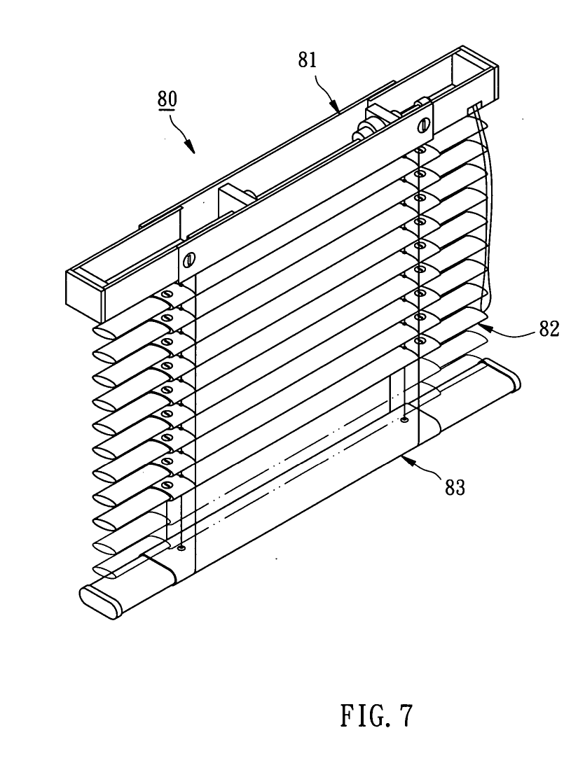

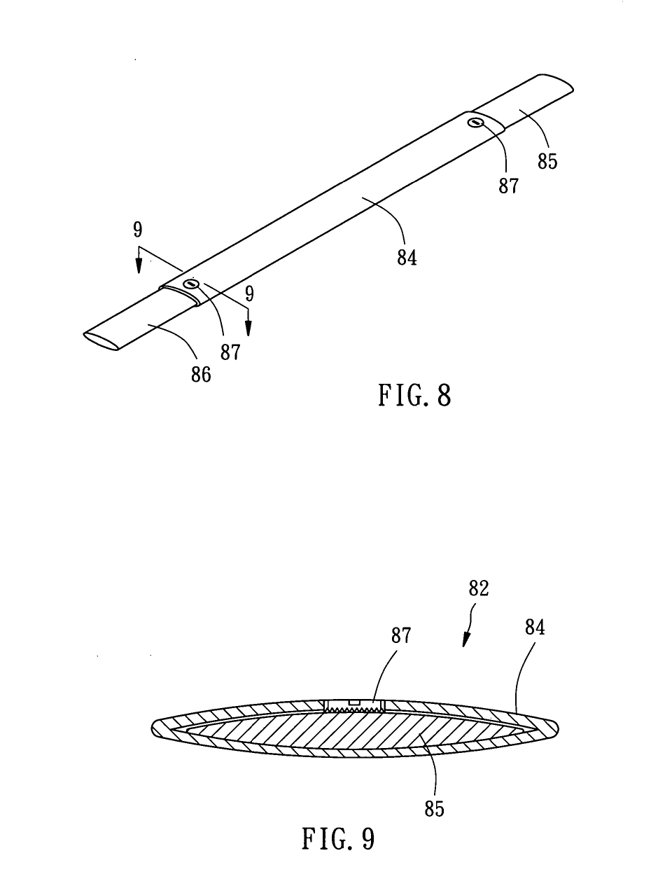

FIGS. 7-9 show a horizontal type window blind 80 constructed according to the third embodiment of the present invention. According to this design, the headrail 81, the retractable slats 82, and the bottom rail 83 each are comprised of three elements that slide one inside another. For example, each slat 82 is comprised of a first slat element 84, a second slat element 85, a third slat element 86, and two retaining members 87. The first slat element 84 has the two distal ends opened. The second slat element 85 and the third slat element 86 are respectively slidably inserted into the two open ends of the first slat element 84. The two retaining members 87 are tightening up screws respectively transversely mounted in the first slat element 84 near the two open ends and adapted to lock the second slat element 85 and the third slat element 86 to the first slat element 84 respectively. Because the retaining members 87 achieve stepless adjustment, graduations can be directly or indirectly marked on the second slat element 85 and the third slat element 86 for position indication. Similar to the aforesaid second embodiment of the present invention, the second slat element 85 and the third slat element 86 each can be made having a base and an adjustment portion wherein the contour of the base is approximately equal to the contour of the first slat element; the contour of the adjustment portion is smaller than the contour of the first slat element; the length of the adjustment portion is sufficient for the adjustment range of 3″, i.e., the total adjustment range of each retractable slat is 6″.

It is to be mentioned that friction resistance may be employed to achieve positioning of the second and third slat elements to the first slat element instead of the use of the above-mentioned retaining member. For example, the second slat element is designed to be inserted into the receiving chamber of the first slat element in a close fit manner, so that the second slat element is slidable and positionable relative to the first slat element without use of the retaining member.

1. A window blind comprising a headrail and a plurality of slats respectively suspended from said headrail, wherein each said slat comprises:
an elongated first slat element; and
an elongated second slat element axially slidably coupled to said first slat element such that said second slat element is movable along a longitudinal axis of said first slat element toward a first end of said first slat element.

2. The window blind as claimed in claim 1, further comprising means for immobilizing said second slat element relative to said first slat element.

3. The window blind as claimed in claim 2, wherein said first slat element comprises a receiving chamber axially extended along the longitudinal axis thereof and an opening in the first end thereof in communication with said receiving chamber; said second slat element has a first end inserted through said opening into said receiving chamber of said first slat element and a second end extended out of said opening of said first slat element.

4. The window blind as claimed in claim 3, wherein said means for immobilizing said second slat element relative to said first slat element comprises a plurality of locating grooves provided at said second slat element, and a retaining block provided at said first slat element and protruded into said receiving chamber and selectively engaged with one of said locating grooves.

5. The window blind as claimed in claim 3, wherein said means for immobilizing said second slat element relative to said first slat element comprises a screw screwed in said first slat element and extendable into said receiving chamber, said screw having a tip stoppable against said second slat element.

6. The window blind as claimed in claim 5, wherein said tip of said screw is serrated.

7. The window blind as claimed in claim 1, wherein said slats are respectively vertically suspended from said headrail; the first slat element and second slat element of each said slat have different colors.

8. The window blind as claimed in claim 2, wherein said slats are horizontally arranged in parallel at different elevations below said headrail.

9. The window blind as claimed in claim 8, wherein said headrail comprises a first headrail element, a second headrail element axially moveably coupled to said first headrail element, and means for immobilizing said second headrail element relative to said first headrail element.

10. The window blind as claimed in claim 8, further comprising a bottom rail provided below said slats, said bottom rail comprising a first bottom rail element, a second bottom rail element axially movably coupled to said first bottom rail element, and means for immobilizing said second bottom rail element relative to said first bottom rail element.

11. The window blind as claimed in claim 8, wherein each said slat further comprises an elongated third slat element axially slidably coupled to said first slat element such that said third slat element is movable along the longitudinal axis of said first slat element toward a second end of said first slat element, and means for immobilizing said third slat element relative to said first slat element.

12. The window blind as claimed in claim 1, wherein said second slat element comprises a base and an adjustment portion extended from one end of said base, said base having a contour approximately equal to that of said first slat element, said adjustment portion having a contour smaller than that of said first slat element and being axially slidably inserted into the first end of said first slat element.

13. A retractable blind slat for a window blind, comprising:
an elongated first slat element; and
an elongated second slat element axially movably coupled to said first slat element such that said second slat element is movable along a longitudinal axis of said first slat element.

14. The blind slat as claimed in claim 13, further comprising means for immobilizing said second slat element relative to said first slat element.

15. The blind slat as claimed in claim 13, wherein said first slat element comprises a receiving chamber axially extended along the longitudinal axis thereof and an opening in a first end thereof in communication with said receiving chamber; said second slat element has a first end inserted through said opening into said receiving chamber of said first slat element and a second end extended out of said opening of said first slat element.

16. The blind slat as claimed in claim 15, wherein said means for immobilizing said second slat element relative to said first slat element comprises a plurality of locating grooves provided at said second slat element, and a retaining block provided at said first slat element and protruded into said receiving chamber and selectively engaged with one of said locating grooves.

17. The blind slat as claim in claim 16, wherein said locating grooves are arranged in parallel at an equal pitch.

18. The blind slat as claimed in claim 13, wherein said second slat element is axially movable relative to said first slat element within a range not greater than 6 inches.

19. The blind slat as claimed in claim 15, wherein said means for immobilizing said second slat element relative to said first slat element comprises a screw screwed in said first slat element and extendable into said receiving chamber, said screw having a tip stoppable against said second slat element.

20. The blind slat as claimed in claim 19, wherein said tip of said screw is serrated.

21. The blind slat as claimed in claim 15, wherein said second slat element has a contour approximately equal to a contour of said receiving chamber of said first slat element.

22. The blind slat as claimed in claim 15, wherein said second slat element comprises a base and an adjustment portion extended from one end of said base, said base having a contour approximately equal to that of said first slat element, said adjustment portion having a contour smaller than that of said first slat element and being axially slidably inserted into said receiving chamber of said first slat element.

23. A retractable blind slat for a window blind, comprising:
an elongated first slat element, said first slat element having a first opening and a second opening respectively formed in two ends thereof and extending along a longitudinal axis thereof;
a second slat element axially slidably inserted into the first opening of said first slat element;
means for immobilizing said second slat element relative to said first slat element;
a third slat element axially slidably inserted into the second opening of said first slat element; and
means for immobilizing said third slat element relative to said first slat element.

24. The blind slat as claimed in claim 23, wherein said first slat element comprises an axially extended receiving chamber in communication between said first opening and said second opening.

25. The blind slat as claimed in claim 24, wherein said means for immobilizing said second slat element relative to said first slat element comprises a plurality of locating grooves provided at said second slat element, and a retaining block provided at said first slat element and protruded into said receiving chamber and selectively engaged with one of said locating grooves; wherein said means for immobilizing said third slat element relative to said first slat element comprises a plurality of locating grooves provided at said third slat element, and a retaining block provided at said first slat element and protruded into said receiving chamber and selectively engaged with one of said locating grooves of said third slat element.

26. The blind slat as claimed in claim 25, wherein the locating grooves of said second and third slat elements are respectively arranged in parallel at an equal pitch.

27. The blind slat as claimed in claim 24, wherein said means for immobilizing said second slat element relative to said first slat element comprises a screw screwed in said first slat element and extendable into said receiving chamber, said screw having a tip stoppable against said second slat element; wherein said means for immobilizing said third slat element relative to said first slat element comprises a screw screwed in said first slat element and extendable into said receiving chamber, said screw having a tip stoppable against said third slat element

28. The blind slat as claimed in claim 27, wherein the tips of said screws are serrated.

29. The blind slat as claimed in claim 23, wherein said second slat element and said third slat element are respectively axially movable relative to said first slat element within a range not greater than 3 inches.

30. The blind slat as claimed in claim 23, wherein said second slat element and said third slat element each comprise a base and an adjustment portion extended from one end of said base, said base having a contour approximately equal to that of said first slat element, said adjustment portion having a contour smaller than that of said first slat element.
